(19) United States
(12) Patent Application Publication
(10) Pub. No.: US 2020/0284273 A1
(43) Pub. Date: Sep. 10, 2020

(54) FLUID DRIVING DEVICE

(71) Applicant: SILICON TOUCH TECHNOLOGY INC., HSINCHU (TW)

(72) Inventors: CHI-YUAN CHIN, HSINCHU (TW); LING-YUAN TSENG, HSINCHU (TW)

(21) Appl. No.: 16/810,264

(22) Filed: Mar. 5, 2020

(30) Foreign Application Priority Data
Mar. 6, 2019 (TW) 108107335

(51) Int. Cl. F15B 15/20

(52) U.S. Cl. CPC F15B 15/20; F15B 2015/208

(57) ABSTRACT

A fluid driving device is provided. The fluid driving device includes: a receiving body having a first side and a second side, wherein the first side and the second side are disposed opposite to each other. A fluid is received in the receiving body, and the receiving body is elastic. A first magnetic force generating module is disposed on the first side, and a second magnetic force generating module is disposed on the second side. The interaction between the first magnetic force generating module and the second magnetic force generating module causes a deformation of the receiving body to drive the fluid to flow.

### CROSS-REFERENCE TO RELATED PATENT APPLICATION

This application claims the benefit of priority to Taiwan Patent Application No. 108107335, filed on Mar. 6, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a fluid driving device, and more particularly to a fluid driving device that does not use thermal energy or mechanical fan rotation as driving power.

### BACKGROUND OF THE DISCLOSURE

In the conventional fluid driving devices, for example, a heat pipe promotes the flow of a fluid therein through the absorption and dissipation of thermal energy to achieve a heat dissipation effect. In addition, an engine or a steam engine drives other devices by converting thermal energy into mechanical energy. In terms of fluid driving methods, the form of energy desired by users can be used only after the thermal energy is absorbed or dissipated by the fluid.

However, conventional sources for heating are still mainly combustible energy sources such as oil, gas, and natural gas. In the near future, these combustible energy sources would be gradually exhausted, which may result in a considerable impact on people's lives.

Therefore, it is an important issue in the industry to provide a device that drives a fluid without using thermal energy.

### SUMMARY OF THE DISCLOSURE

In response to the above-referenced technical inadequacies, the present disclosure provides a fluid driving device. The fluid driving device includes: a receiving body having a first side and a second side, wherein the first side and the second side are disposed opposite to each other, a fluid is received in the receiving body, and the receiving body is elastic; a first magnetic force generating module disposed on the first side; and a second magnetic force generating module disposed on the second side. The interaction between the first magnetic force generating module and the second magnetic force generating module causes a deformation of the receiving body to drive the fluid to flow.

In the present disclosure, the magnetic force generating module is controlled by electric energy, and the receiving body of the fluid driving device is deformed through the attraction and repulsion of the magnetic force, thereby driving the fluid in the receiving body. The use of thermal energy can be effectively reduced, and the velocity and direction of the fluid can be controlled through the deformation of the receiving body.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram of a fluid driving device according to an embodiment of the present disclosure.

FIG. 2 is a schematic diagram of the interaction between a first magnetic force generating module and a second magnetic force generating module of the fluid driving device according to the embodiment of the present disclosure.

FIG. 3 is another schematic diagram of the interaction between the first magnetic force generating module and the second magnetic force generating module of the fluid driving device according to the embodiment of the present disclosure.

FIG. 4 is yet another schematic diagram of the interaction between the first magnetic force generating module and the second magnetic force generating module of the fluid driving device according to the embodiment of the present disclosure.

FIG. 5 is a functional block diagram of the fluid driving device according to the embodiment of the present disclosure.

FIG. 6A is still another schematic diagram of the interaction between the first magnetic force generating module and the second magnetic force generating module of the fluid driving device according to the embodiment of the present disclosure.

FIG. 6B is still another schematic diagram of the interaction between the first magnetic force generating module and the second magnetic force generating module of the fluid driving device according to the embodiment of the present disclosure.

FIG. 7 is a cross-sectional diagram of the fluid driving device taken along section line VII-VII of FIG. 1.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

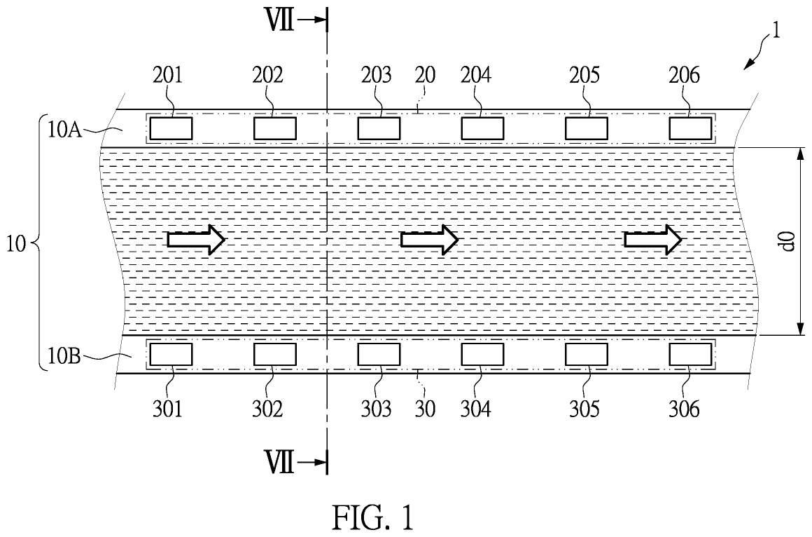

Referring to FIG. 1, FIG. 1 is a schematic diagram of a fluid driving device according to an embodiment of the present disclosure.

In this embodiment, the fluid driving device 1 includes a receiving body 10, a first magnetic force generating module 20, and a second magnetic force generating module 30.

The receiving body 10 has a first side 10A and a second side 10B. The first side 10A and the second side 10B are disposed opposite to each other. In this embodiment, the receiving body 10 is a pipe body for receiving a fluid. The fluid includes gas (such as air) or liquid (such as water). In addition, the material of the receiving body is an elastic material. In an actual design, the receiving body 10 only needs to be a mechanism design or a material having deformability. In this embodiment, the pipe wall of the receiving body 10 has a thickness.

In this embodiment, the first magnetic force generating module 20 is disposed on the first side 10A of the receiving body 10. The second magnetic force generating module 30 is disposed on the second side 10B of the receiving body 10. The interaction between the first magnetic force generating module 20 and the second magnetic force generating module 30 causes a deformation at least a part of the receiving body 10, so that the fluid received in the receiving body 10 flows. That is, the magnetic force of the first magnetic force generating module 20 and the second magnetic force generating module 30 causes the receiving body 10 to deform, so that the internal space of the receiving body 10 is changed to drive the fluid in the receiving space 10 to flow in accordance with the deformation.

In this embodiment, the first magnetic force generating module 20 and the second magnetic force generating module 30 are disposed in a pipe wall of the receiving body 10. That is, the first magnetic force generating module 20 and the second magnetic force generating module 30 are disposed in the first side 10A and the second side 10B of the receiving body 10, respectively. In other embodiments, the first magnetic force generating module 20 and the second magnetic force generating module 30 can be disposed outside or inside of the pipe wall of the receiving body 10, which can be adjusted and designed according to actual needs, and is not limited in the present disclosure.

Referring to FIG. 1, the first magnetic force generating module 20 and the second magnetic force generating module 30 include a plurality of magnetic force generating units, respectively. In this embodiment, the first magnetic force generating module 20 includes a first magnetic force generating unit 201, a second magnetic force generating unit 202, a third magnetic force generating unit 203, a fourth magnetic force generating unit 204, a fifth magnetic force generating unit 205, and a sixth magnetic force generating unit 206. The second magnetic force generating module 30 includes a seventh magnetic force generating unit 301, an eighth magnetic force generating unit 302, a ninth magnetic force generating unit 303, a tenth magnetic force generating unit 304, an eleventh magnetic force generating unit 305, and a twelfth magnetic force generating unit 306.

The first magnetic force generating unit 201, the second magnetic force generating unit 202, the third magnetic force generating unit 203, the fourth magnetic force generating unit 204, the fifth magnetic force generating unit 205, and the sixth magnetic force generating unit 206 of the first magnetic force generating module 20 are disposed opposite and pairwise to the seventh magnetic force generating unit 301, the eighth magnetic force generating unit 302, the ninth magnetic force generating unit 303, the tenth magnetic force generating unit 304, the eleventh magnetic force generating unit 305, and the twelfth magnetic force generating unit 306 of the second magnetic force generating module 30, respectively. That is, in this embodiment, the first magnetic force generating unit 201 is disposed on the opposite side of the seventh magnetic force generating unit 301. The second magnetic force generating unit 202 is disposed on the opposite side of the eighth magnetic force generating unit 302. The third magnetic force generating unit 203 is disposed on the opposite side of the ninth magnetic force generating unit 303. The fourth magnetic force generating unit 204 is disposed on the opposite side of the tenth magnetic force generating unit 304. The fifth magnetic force generating unit 205 is disposed on the opposite side of the eleventh magnetic force generating unit 305. The sixth magnetic force generating unit 206 is disposed on the opposite side of the twelfth magnetic force generating unit 306.

In this embodiment, the plurality of magnetic force generating units 201-206 of the first magnetic force generating module 20 and the plurality of magnetic force generating units 301-306 of the second magnetic force generating module 30 each have a plurality of magnetic poles. The receiving body 10 generates a deformation according to the attraction or repulsion of the plurality of magnetic poles of the plurality of magnetic force generating units 201-206 of the first magnetic force generating module 20 and the plurality of magnetic force generating units 301-306 of the second magnetic force generating module 30. That is, the inner diameter of the receiving body 10 is increased or decreased according to the attraction or repulsion of the plurality of magnetic poles of the plurality of magnetic force generating units 201-206 of the first magnetic force generating module 20 and the plurality of magnetic force generating units 301-306 of the second magnetic force generating module 30. In FIG. 1, the inner diameter of the receiving body 10 is an initial distance d0.

Furthermore, one of the magnetic force generating units 201-206 of the first magnetic force generating module 20 is a first magnetic pole. One of the plurality of magnetic force generating units 301-306 of the second magnetic force generating module 30 disposed on the opposite side is a second magnetic pole, and the first magnetic pole and the second magnetic pole have the same polarity (both are S poles or N poles), and therefore repel each other. An inner diameter of a pipe-wall region of the receiving body 10 provided with one of the plurality of magnetic force generating units 201-206 of the first magnetic force generating module 20 and the plurality of magnetic force generating units 301-306 of the second magnetic force generating module 30 is increased.

One of the magnetic force generating units 201-206 of the first magnetic force generating module 20 is a first magnetic pole. One of the plurality of magnetic force generating units 301-306 of the second magnetic force generating module 30 disposed on the opposite side is a second magnetic pole, and the first magnetic pole and the second magnetic pole have different polarities (one is S pole, and the other is N pole), and therefore attract each other. An inner diameter of a pipe-wall region of the receiving body 10 provided with one of the plurality of magnetic force generating units 201-206 of the first magnetic force generating module 20 and the plurality of magnetic force generating units 301-306 of the second magnetic force generating module 30 is decreased.

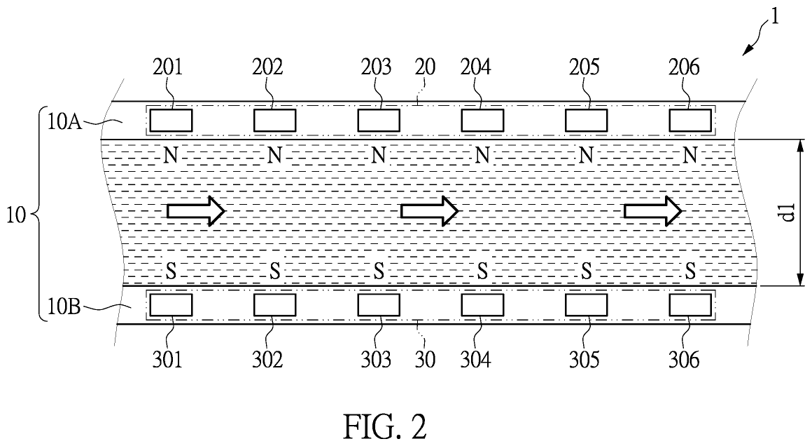

Referring to FIG. 2, FIG. 2 is a schematic diagram of the interaction between a first magnetic force generating module and a second magnetic force generating module of the fluid driving device according to the embodiment of the present disclosure.

A plurality of magnetic poles of the plurality of magnetic force generating units 201-206 of the first magnetic force generating module 20 are N poles. A plurality of magnetic poles of the plurality of magnetic force generating units 301-306 of the second magnetic force generating module 30 are S poles. The plurality of magnetic poles of the first magnetic force generating module 20 and the plurality of magnetic poles of the second magnetic force generating module 30 are different magnetic poles, and therefore attract each other. In this embodiment, the first magnetic force generating module 20 and the second magnetic force generating module 30 are disposed in the pipe wall of the receiving body 10, and therefore, the pipe walls on both sides of the receiving body 10 are close to each other due to the attracting magnetic force. In this case, the inner diameter of the receiving body 10 is a first distance d1. The first distance d1 is less than the initial distance d0.

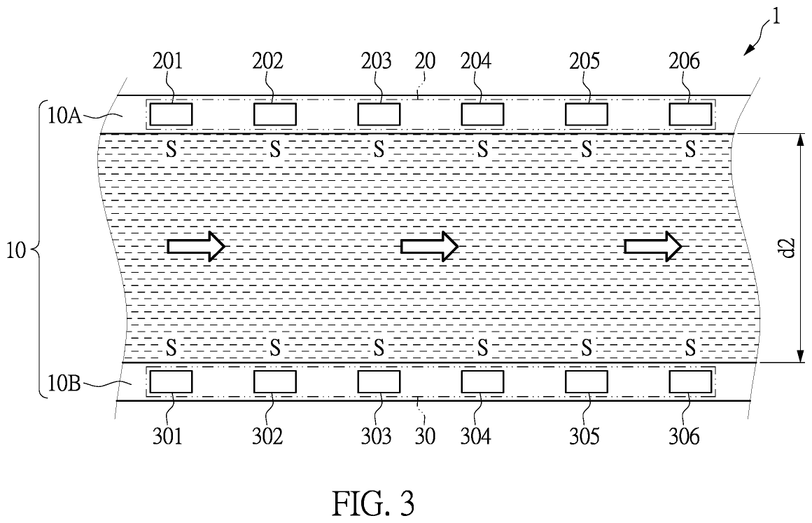

Referring to FIG. 3, FIG. 3 is another schematic diagram of the interaction between the first magnetic force generating module and the second magnetic force generating module of the fluid driving device according to the embodiment of the present disclosure.

A plurality of magnetic poles of the plurality of magnetic force generating units 201-206 of the first magnetic force generating module 20 are S poles. A plurality of magnetic poles of the plurality of magnetic force generating units 301-306 of the second magnetic force generating module 30 are also S poles. The plurality of magnetic poles of the first magnetic force generating module 20 and the plurality of magnetic poles of the second magnetic force generating module 30 are the same magnetic poles, and therefore repel each other. In this embodiment, the first magnetic force generating module 20 and the second magnetic force generating module 30 are disposed in the pipe wall of the receiving body 10, and therefore, the pipe walls on both sides of the receiving body 10 are close to each other due to the repelling magnetic force. In this case, the inner diameter of the receiving body 10 is a second distance d2. The second distance d2 is greater than the initial distance d0 and the first distance d1.

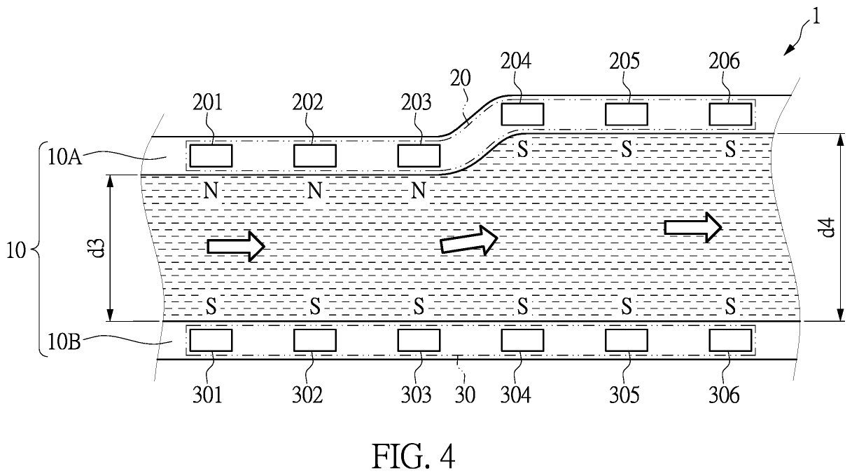

Referring to FIG. 4, FIG. 4 is yet another schematic diagram of the interaction between the first magnetic force generating module and the second magnetic force generating module of the fluid driving device according to the embodiment of the present disclosure.

In this embodiment, the magnetic poles of the first magnetic force generating unit 201, the second magnetic force generating unit 202, and the third magnetic force generating unit 203 of the first magnetic force generating module 20 are N poles. The magnetic poles of the fourth magnetic force generating unit 204, the fifth magnetic force generating unit 205, and the sixth magnetic force generating unit 206 of the first magnetic force generating module 20 are S poles. A plurality of magnetic poles of the plurality of magnetic force generating units 301-306 of the second magnetic force generating module 30 are S poles.

That is, the magnetic poles of the first magnetic force generating unit 201, the second magnetic force generating unit 202, and the third magnetic force generating unit 203, and the magnetic poles of the seventh magnetic force generating unit 301, the eighth magnetic force generating unit 302, and the ninth magnetic force generating unit 303 are different magnetic poles, and therefore attract each other. Therefore, the inner diameter of the pipe-wall region where the first magnetic force generating unit 201, the second magnetic force generating unit 202, the third magnetic force generating unit 203, the seventh magnetic force generating unit 301, the eighth magnetic force unit 302, and the ninth magnetic force generating unit 303 are disposed is decreased.

The magnetic poles of the fourth magnetic force generating unit 204, the fifth magnetic force generating unit 205, and the sixth magnetic force generating unit 206, and the magnetic poles of the tenth magnetic force generating unit 304, the eleventh magnetic force generating unit 305, and the twelfth magnetic force generating unit 306 are the same magnetic poles, and therefore repel each other. Therefore, the inner diameter of the pipe-wall region where the fourth magnetic force generating unit 204, the fifth magnetic force generating unit 205, the sixth magnetic force generating unit 206, the tenth magnetic force generating unit 304, the eleventh magnetic force unit 305, and the twelfth magnetic force generating unit 306 are disposed is increased. In this embodiment, the distance between the first magnetic force generating unit 201, the second magnetic force generating unit 202, and the third magnetic force generating unit 203, and that of the seventh magnetic force generating unit 301, the eighth magnetic force unit 302, and the ninth magnetic force generating unit 303 is a third distance d3. The distance between the fourth magnetic force generating unit 204, the fifth magnetic force generating unit 205, and the sixth magnetic force generating unit 206, and that of the tenth magnetic force generating unit 304, the eleventh magnetic force generating unit 305, and the twelfth magnetic force generating unit 306 is a fourth distance d4. The third distance d3 is less than the fourth distance d4.

In this embodiment, the plurality of magnetic force generating units of the first magnetic force generating module 20 and the second magnetic force generating module 30 are electromagnets. That is, the magnetic force generating units 201-206 and the magnetic force generating units 301-306 include at least one coil and a conductor.

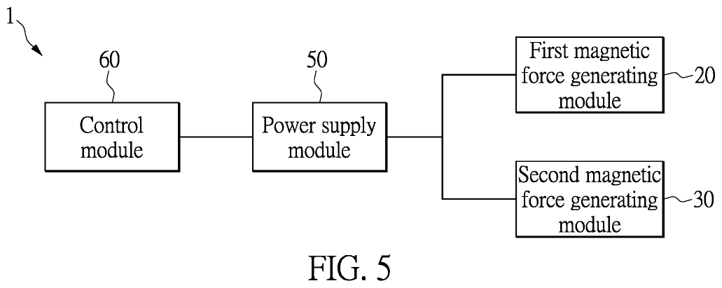

Referring to FIG. 5, FIG. 5 is a functional block diagram of the fluid driving device according to the embodiment of the present disclosure.

In this embodiment, the fluid driving device 1 further includes a power supply module 50 and a control module 60. The control module 60 is electrically connected to the power supply module 50. The power supply module 50 is electrically connected to the first magnetic force generating module 20 and the second magnetic force generating module 30.

The power supply module provides power to each of the plurality of magnetic force generating units of the first magnetic force generating module 20 and the second magnetic force generating module 30 to generate a plurality of magnetic poles.

In this embodiment, the inner diameter of the pipe body of the receiving body 10 can be increased or decreased by each of the plurality of magnetic force generating units of the first magnetic force generating module 20 and the second magnetic force generating module 30. Therefore, the fluid in the receiving body 10 can flow in different directions and at different velocities by changing the space inside the receiving body 10.

In this embodiment, the control module 60 provides a control signal to the power supply module 50. The voltage magnitude and the current direction, etc. provided by the power supply module 50 to the first magnetic module 20 and the second magnetic module 30 can be controlled to control the plurality of magnetic force generating units of the first magnetic module 20 and the second magnetic module 30 to generate different magnetic poles, different magnitudes of magnetic force, different magnetic pole arrangements, and the changing order of different magnetic poles.

That is, the power supply module 50 provides power to the first magnetic force generating module 20 and the second magnetic force generating module 30 according to the control signal.

In this embodiment, the first side 10A or the second side 10B of the receiving body 10 is fixedly disposed on a fixed point or a plane. That is, taking the first side 10A or the second side 10B of the receiving body 10 as a reference point, the deformation of the receiving body 10 can be further calculated and planned.

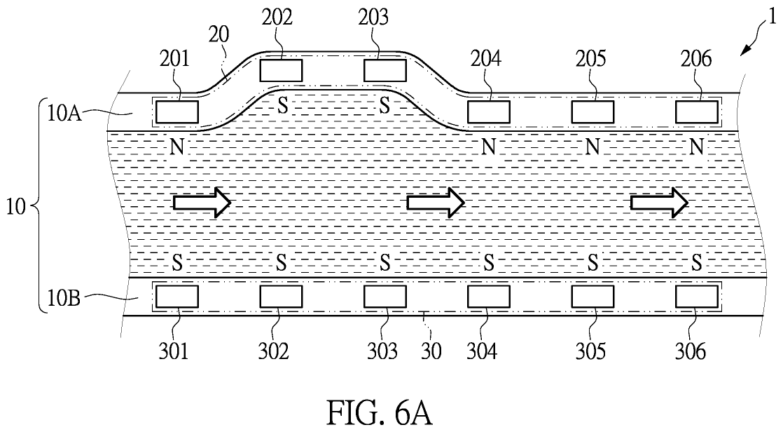

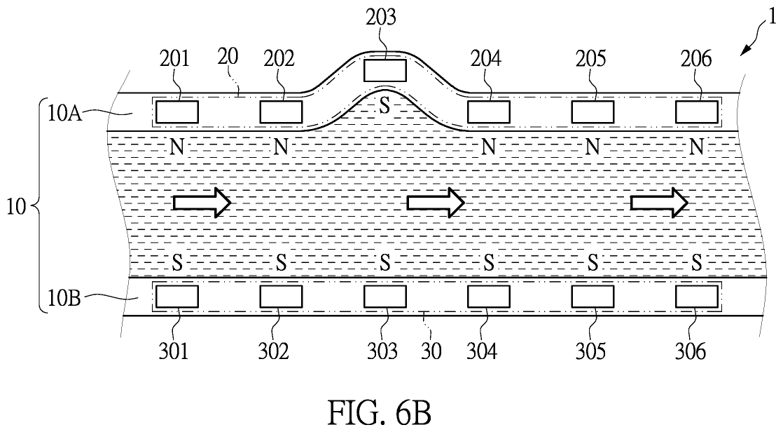

Referring to FIGS. 6A and 6B, FIG. 6A is still another schematic diagram of the interaction between the first magnetic force generating module and the second magnetic force generating module of the fluid driving device according to the embodiment of the present disclosure. FIG. 6B is still another schematic diagram of the interaction between the first magnetic force generating module and the second magnetic force generating module of the fluid driving device according to the embodiment of the present disclosure.

For ease of illustration, in this embodiment, the magnetic poles of the plurality of magnetic force generating units 301-306 of the second magnetic force generating module 30 are S poles. Therefore, the plurality of magnetic poles of the second magnetic force generating module 30 are presented as S poles. In other embodiments, the plurality of magnetic poles of the first magnetic force generating module 20 can be preset to have the same polarity. It is also possible not to set any preset value.

In this embodiment, the second side 10B of the receiving body 10 is fixedly disposed on a fixed point or a plane. Therefore, the change in the inner diameter of the receiving body 10 can be clearly observed.

As shown in FIG. 6A, a region between the second magnetic force generating unit 202, the third magnetic force generating unit 203, the ninth magnetic force generating unit 303, and the tenth magnetic force generating unit 304 is greater than a region between other magnetic force generating units.

In this case, the magnetic pole of the second magnetic force generating unit 202 changes, and is converted from the S pole to the N pole. The fluid between the second magnetic force generating unit 202 and the eighth magnetic force generating unit 302 is squeezed to move toward the direction of the third magnetic force generating unit 203 and the ninth magnetic force generating unit 303. In this case, the magnetic force between the first magnetic force generating unit 201 and the seventh magnetic force generating unit 301 needs to be increased to cause the fluid to move toward the direction of the third magnetic force generating unit 203 and the ninth magnetic force generating unit 303. In this embodiment, the inner diameter of the receiving body 10 can be increased or decreased through the magnetic force generated by the first magnetic force generating module 20 and the second magnetic force generating module 30, that is, the cross-sectional area inside the receiving body 10 is changed. That is, the cross-sectional area of the receiving body 10 is a non-linear function value of the magnetic force generated by the first magnetic force generating module 20 and the second magnetic force generating module 30, as shown in the following formula 1:

Area=Func(Fmag) Formula 1.

In formula 1, Area is the cross-sectional area inside the receiving body 10, and Fmag is the magnetic force generated between a plurality of magnetic force generating units.

In this embodiment, the magnetic force between a plurality of magnetic force generating units can be changed in magnitude according to the power provided by the power supply module 50. Therefore, the magnetic force Fmag can also be divided into a plurality of levels.

Furthermore, since the cross-sectional area of the receiving body 10 is changed, the velocity of the fluid is affected.

That is, the fluid in the receiving body 10 follows the following formula 2. Formula 2 is the relationship between the velocity of the fluid in a continuous container and the cross-sectional area, as follows:

A1*V1=A2*V2 Formula 2.

It can be known from formula 2 that the velocity of the fluid is in inverse proportion with the cross-sectional area of the container through which the fluid flows. That is, the larger the cross-sectional area is, the slower the fluid velocity is. The smaller the cross-sectional area is, the faster the fluid velocity is.

In this embodiment, the flow direction and velocity of the fluid in the receiving body 10 can be effectively controlled by controlling the magnitude of the magnetic force and the change order of the magnetic poles.

In this embodiment, the number and setting positions of the receiving bodies 10, the magnetic force generating modules, the magnetic force generating units can be adjusted and designed according to actual needs, and is not limited in the present disclosure.

Since the fluid in the receiving body 10 can be gas or liquid, the fluid driving device 1 of the present disclosure can be used in a heat dissipation system to effectively control the efficiency of heat dissipation through the movement of the gas or liquid.

Moreover, since the driving of the gas or liquid can also be used as a power source, it can be used as a power source for underwater transport equipment, waterborne equipment, or airborne equipment.

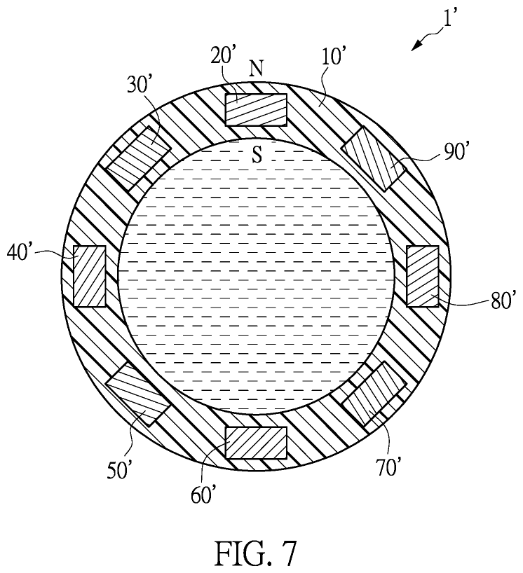

Referring to FIG. 7, FIG. 7 is a cross-sectional diagram of the fluid driving device taken along section line VII-VII of FIG. 1.

In this embodiment, the fluid driving device 1′ includes a receiving body 10′, a first magnetic force generating module 20′, a second magnetic force generating module 30′, a third magnetic force generating module 40′, a fourth magnetic force generating module 50′, a fifth magnetic force generating module 60′, a sixth magnetic force generating module 70′, a seventh magnetic force generating module 80′, and an eighth magnetic force generating module 90′.

In this embodiment, the first magnetic force generating module 20′, the second magnetic force generating module 30′, the third magnetic force generating module 40′, the fourth magnetic force generating module 50′, the fifth magnetic force generating module 60′, the sixth magnetic force generating module 70′, the seventh magnetic force generating module 80′, and the eighth magnetic force generating module 90′ are disposed opposite and pairwise to each other in the receiving body 10′. That is, the first magnetic force generating module 20′ is disposed opposite to the fifth magnetic force generating module 60′. The second magnetic force generating module 30′ is disposed opposite to the sixth magnetic force generating module 70′. The third magnetic force generating module 40′ is disposed opposite to the seventh magnetic force generating module 80′. The fourth magnetic force generating module 50′ is disposed opposite to the eighth magnetic force generating module 90′.

In this embodiment, the magnetic force adjustment mode of each magnetic force generating module can be more flexible. As shown in FIG. 7, the magnetic pole of the first magnetic force generating module 20′ can be used as a reference to adjust the magnetic poles and the magnitudes of magnetic force of other magnetic force generating modules.

In this embodiment, the volume change of the receiving body 10′ can be accelerated, increased or adjusted by adopting a plurality of sets of magnetic force generating modules to effectively adjust the velocity of the fluid in the receiving body 10′, thereby increasing the forward force or setback force of the fluid.

### Advantageous Effects of Embodiments

In the present disclosure, the magnetic force generating module is controlled by electric energy, and the receiving body of the fluid driving device is deformed through the attraction and repulsion of the magnetic force, thereby driving the fluid in the receiving body. Therefore, the use of thermal energy can be effectively reduced, and the velocity and direction of the fluid can be controlled through the deformation of the receiving body.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A fluid driving device, comprising:
a receiving body having a first side and a second side, wherein the first side and the second side are disposed opposite to each other, a fluid is received in the receiving body, and the receiving body is elastic;
a first magnetic force generating module disposed on the first side; and
a second magnetic force generating module disposed on the second side;
wherein an interaction between the first magnetic force generating module and the second magnetic force generating module causes a deformation of the receiving body to drive the fluid to flow.

2. The fluid driving device according to claim 1, wherein the first magnetic force generating module includes a plurality of magnetic force generating units; the second magnetic force generating module includes a plurality of magnetic force generating units; the plurality of magnetic force generating units of the first magnetic force generating module and the plurality of magnetic force generating units of the second magnetic force generating module generate a plurality of magnetic poles, respectively; the receiving body generates the deformation according to the plurality of magnetic poles of the plurality of magnetic force generating units of the first magnetic force generating module and the plurality of magnetic force generating units of the second magnetic force generating module.

3. The fluid driving device according to claim 2, further comprising:
a control module; and
a power supply module electrically connected to the control module, the first magnetic force generating module, and the second magnetic force generating module, so that the respective plurality of magnetic force generating units of the first magnetic force generating module and the second magnetic force generating module generate the magnetic poles;
wherein the control module provides a control signal to the power supply module, and the power supply module provides power to the first magnetic force generating module and the second magnetic force generating module according to the control signal.

4. The fluid driving device according to claim 3, wherein one of the magnetic force generating units of the first magnetic force generating module is a first magnetic pole, and one of the plurality of magnetic force generating units of the second magnetic force generating module disposed on an opposite side is a second magnetic pole; and the first magnetic pole and the second magnetic pole have a same polarity, and an inner diameter of a section of the receiving body provided with one of the plurality of magnetic force generating units of the first magnetic force generating module and the plurality of magnetic force generating units of the second magnetic force generating module is increased.

5. The fluid driving device according to claim 4, wherein one of the magnetic force generating units of the first magnetic force generating module is a first magnetic pole, and one of the plurality of magnetic force generating units of the second magnetic force generating module disposed on the opposite side is a second magnetic pole; and the first magnetic pole and the second magnetic pole have different polarities, and an inner diameter of a section of the receiving body provided with one of the plurality of magnetic force generating units of the first magnetic force generating module and the plurality of magnetic force generating units of the second magnetic force generating module is decreased.

6. The fluid driving device according to claim 4, wherein the plurality of magnetic force generating units of the first magnetic force generating module and the second magnetic force generating module are controlled by a control signal provided by a control module to generate different magnetic poles, different magnitudes of magnetic force, different magnetic pole arrangements, and different magnetic pole change orders, so that the inner diameters of different parts of the receiving body are increased or decreased to drive the fluid in the receiving body.

7. The fluid driving device according to claim 1, wherein the first side or the second side of the receiving body is fixedly disposed on a fixed point or a plane.

8. The fluid driving device according to claim 1, wherein the first magnetic force generating module is disposed in the first side of the receiving body, and the second magnetic force generating module is disposed in the second side of the receiving body.

9. The fluid driving device according to claim 1, wherein the first magnetic force generating module is disposed outside of a pipe wall of the receiving body, and the second magnetic force generating module is disposed outside of the pipe wall of the receiving body.

10. The fluid driving device according to claim 1, wherein the first magnetic force generating module is disposed inside of a pipe wall of the receiving body, and the second magnetic force generating module is disposed inside of the pipe wall of the receiving body.

11. A fluid driving device, comprising:
a receiving body in which a fluid is received, the receiving body being elastic; and
a plurality of magnetic force generating modules disposed opposite and pairwise to each other on the receiving body;
wherein the receiving body generates at least one deformation through an interaction of the plurality of magnetic force generating modules to drive the fluid to flow.
